(19) United States
(12) Patent Application Publication
(10) Pub. No.: US 2015/0024882 A1
(43) Pub. Date: Jan. 22, 2015

(54) Driven Clutch with Engine Braking for a Continuously Variable Transmission

(71) Applicant: The Hilliard Corporation, Elmira, NY (US)

(72) Inventors: David C. Ochab, Horseheads, NY (US); Scott C. Schneider, Vestal, NY (US)

(21) Appl. No.: 13/947,703

(22) Filed: Jul. 22, 2013

(51) Int. Cl. F16H 9/16

(52) U.S. Cl. CPC F16H 9/16; F16H 2200/00
USPC 474/19

(57) ABSTRACT

A driven clutch for continuously variable transmission for a vehicle, the driven clutch permitting engine braking. The clutch includes an output shaft with first and second sheaves. The first sheave is substantially inhibited from moving axially along the output shaft but may be relatively unrestrained rotationally. The second sheave is axially and rotationally movable with respect to the shaft. A slot is formed in the output shaft and adapted to engage with second sheave for providing torque transmission between the second sheave and the output shall. A compression spring is disposed between the helix and the second sheave for biasing the second sheave toward the first sheave.

### TECHNICAL FIELD

The invention relates to vehicle transmission systems and, more particularly, to an improved driven clutch which provides efficient torque transfer for both driving and engine braking.

### BACKGROUND OF THE INVENTION

Continuously variable transmissions (CVT's) are used in many types of vehicles, including off-road or all terrain vehicles, to alleviate any need for the driver to shift the transmission as the vehicle accelerates through its range of speeds. Typically the CVT is connected between an output shaft of a vehicle's engine and the driven components (e.g., axle). Like a conventional transmission, a CVT provides a gear reduction from the relatively high speed engine output shaft and the lower speed vehicle drive axle. The primary difference is that a CVT provides a continuously variable gear reduction based on commanded acceleration and deceleration.

A CVT may be used to drive an axle directly or, if desired, may be used in conjunction with an additional gear box/transmission. For example, on all terrain vehicles (ATVs) it is desirable to provide a gear box to permit the driver to shift between forward and reverse gears. In such transmissions, a neutral position may also be provided, along with, for example, an optional low gear for extra power at low speeds. Typically such a gear box is connected to the output shaft of the CVT. The gear box, in turn, has an output connected by suitable linkages to the drive axle (or axles) of the vehicle. The year box or transmission may also be used to provide further gear reduction in addition to the reduction provided by the CVT. Also, additional drive train components, such as differentials, may be incorporated between the CVT and the drive axle(s).

Typically a CVT transmission includes a split sheave primary drive clutch connected to the output of the vehicle engine and a split sheave secondary or driven clutch connected (often through additional drive train linkages) to the vehicle axle. An endless, flexible, generally V-shaped drive belt is disposed about the clutches and provides for the transmission of torque between the two clutches. Each of the clutches has a pair of complementary sheaves with one of the sheaves being laterally movable with respect to the other. The effective gear ratio of the transmission is determined by the position of the movable sheave relative to the other sheave in each of the clutches (which varies the position of the belt on the clutches.)

The primary drive clutch has its sheaves normally biased apart, typically by a coil spring, so that when the engine is idling the drive belt does not effectively engage the sheaves. As a result, essentially no driving force is transmitted from the primary drive clutch to the secondary driven clutch. The secondary driven clutch has its sheaves normally biased together, typically by a torsion spring working in combination with a helix-type cam, as described below. As a result, when the engine is at idle, the drive belt rides near the outer perimeter of the secondary driven clutch sheaves.

The spacing of the sheaves in the primary drive clutch usually is controlled by centrifugal flyweights. As the drive clutch rotates faster (in response to increased engine RPM) the flyweights urge the movable sheave toward the stationary sheave. This pinches the drive belt, causing the belt to begin rotating with the drive clutch. The belt, in turn, transmits torque to the driven clutch, causing it to rotate. Further movement of the drive clutch's movable sheave toward the stationary sheave threes the belt to climb radially outward on the drive clutch sheaves, increasing the effective diameter of the drive belt path around the drive clutch. Thus, the spacing of the sheaves in the drive clutch changes based on engine RPM. The drive clutch is, therefore, primarily speed sensitive.

As the sheaves of the drive clutch pinch the drive belt and force the belt to climb outwardly on the drive clutch sheaves, the belt (not being stretchable) is pulled inwardly between the sheaves of the driven clutch, decreasing the effective diameter of the drive belt path around the driven clutch. This movement of the belt outwardly and inwardly on the drive and driven clutches smoothly changes the effective gear ratio of the transmission in infinitely variable increments.

Although a coil spring could be used to bias the sheaves of the secondary or driven clutch together, typically a torque-sensitive system is used to pinch the belt harder as more torque is conveyed by the drive belt to the driven clutch. A generally cylindrical cam with, for example, three cam surfaces (often called ramps) on one end is secured to the output shaft of the driven clutch. Because the ramps are generally helical in shape, the cam is often referred to as a helix. A set of a corresponding number of cam followers—typically buttons or rollers—is mounted to the movable sheave.

The movable sheave, in tint, is disposed about the output shaft so that it is free to move laterally and rotatably with respect to the shaft. The buttons or rollers are located on the movable sheave at positions that permit contact with the ramps of the helix. A torsion spring is typically used to urge the movable sheave rotationally and laterally such that the rollers are engaged against their respective helix ramps. The acceleration ramp of the helix, which is configured (angled) so as to restrict or control upshifting, operates in combination with the spring to determine the upshifting, characteristics of the clutch.

As torque is transmitted by the drive belt to the driven clutch sheaves, the belt tends to urge the moveable sheave laterally away from the stationary sheave, while at the same time rotating the movable sheave with respect to the output shaft. However, the torsion spring urges the buttons against the acceleration ramps, thus engaging the movable sheave with the helix. As torque is applied by the belt to the movable sheave, the slope of the ramp causes the buttons to slide on the ramps toward the stationary sheave, pushing the movable sheave towards the stationary sheave. Thus, the helix converts the torque applied by the drive belt to a force that pinches the sheaves together, providing good frictional contact between the sheaves and the drive belt. The more torque applied by the belt to the driven clutch, the harder the sheaves of the driven clutch pinch the belt, thereby preventing the belt from slipping, while at the same time producing downshifting of the transmission (i.e., urging the belt outwardly between the sheaves of the driven clutch, which urges the belt to move inwardly between the sheaves of the drive clutch). Thus, the spacing of the sheaves in the driven clutch changes based on torque. The driven clutch is, therefore, primarily torque sensitive.

The actual position of the belt within the sheaves of the drive and driven clutches is determined by the balance of the forces acting on the moveable sheaves in the two clutches. In the drive clutch, these forces consist of the coil spring urging the sheaves apart and the speed-dependent force of the centrifugal flyweights which urge the sheaves together. In the driven clutch, these forces include the torque-dependent force venerated by the rollers/buttons sliding up the helix ramps toward the stationary sheave and the torsion spring urging the rollers/buttons into contact with the helix.

Since a CVT automatically adjusts based on speed and torque, the balance of forces can be disrupted relatively easily in variable operating conditions. For example, when the vehicle is traveling along at a given speed and then the rider momentarily lets off on the throttle, the balance of forces changes, causing the system to momentarily shift out of the desired ratio. When the operator reapplies the throttle, torque is restored to the driven clutch, but the transmission is no longer in its optimal gear ratio, requiring the system to readjust. Similarly, if the drive wheels momentarily leave the ground but the operator does not let off on the throttle, the load on the drive wheels is reduced, again disrupting the balance of forces within the CVT and causing it to temporarily shift out of the existing gear ratio. When load is restored to the drive wheels, the CVT must again readjust to the proper gear ratio.

In situations where the CVT must quickly downshift upshift to return to a proper or desired gear ratio, the belt must move outwardly or inwardly between the sheaves of the driven clutch. This belt movement may be inhibited by the need of the moveable sheave to rotate with respect to the stationary sheave as the rollers/buttons travel along the helix ramp. Consequently, as one sheave rotates with respect to the other, it scrubs the sides of the drive belt producing frictional forces which inhibit smooth and quick shifting of the CVT.

Also, because of their dynamic operation, conventional CVT's do not provide significant engine braking through backdriving the engine. That is, in some types of vehicle drive trains when the vehicle is traveling along at a given speed and then the throttle is dropped, to an idle speed, the rotation of the drive wheels of the vehicle will backdrive the drive train, causing the engine to rotate at a speed greater than it otherwise would (based on throttle position). As such, the inherent frictional forces present throughout the drive train, including particularly the compression forces present in the engine cylinders, tend to slow the vehicle down. This condition is commonly referred to as engine braking, and is particularly beneficial in off-road vehicles. The degree of engine braking provided is dependent on the gear ratio of the transmission. That is, higher gears produce less braking while lower gears produce more.

In a CVT, loss of the force balance between the drive and driven clutches when the rider lets off on the throttle including, in particular, the loss of the torque-induced pinching force by the helix on the belt, reduces the engine-braking potential of the CVT. Furthermore, conventional CVT systems do not provide engine braking when the engine speed is at idle since the sheaves on the drive clutch are biased apart by a coil spring thus, not engaging the drive belt. More specifically, in order to prevent the vehicle from “creeping” while in idle, the drive belt usually has a little slack in the idle position to prevent the input shaft of the drive clutch from imparting any rotation to the drive belt. However, the slack in the drive belt prevents the driven clutch from backdriving the engine through the drive clutch when in the idle position.

An improved CVT system is disclosed in U.S. Pat. No. 6,149,540. in that CVT, a roller clutch is mounted in both the drive and the driven clutches. The clutches and drive belt are configured so that when the engine is idling the belt firmly engages a drive surface of the roller clutch that is connected to the drive clutch. The roller clutch permits the drive surface and, thus, the belt to remain stationary when the input shaft is rotating, thereby preventing vehicle “creep” when idling. The roller clutch also is designed to firmly engage the drive clutch's drive surface with the input shaft when the driven clutch attempts to drive the belt faster than the speed at which the drive clutch and input shaft are rotating. This permits the driven clutch to backdrive the input shaft and engine for providing, engine braking to the vehicle.

In order for the CVT in U.S. Pat. No. 6,149,540 to provide the necessary engine braking, the helix is allowed to rotate relative to the sheaves by means of the overrunning clutch, thus, overcoming the friction that exists between the sheaves and the belt.

While U.S. Pat. No. 6,149,540 provides an improved CVT system that works well in general, it is rather costly to manufacture and, thus, limited to use in more expensive vehicles. Furthermore, the roller clutch in the driven clutch is configured so as to only transmit torque in one direction (i.e., during acceleration.)

As discussed above, driven clutches in CVT systems include a helix cam. The helix cam is generally a separate component that is mounted to one of the sheaves. This arrangement is necessary given the configuration of the assembly. The overall assembly results in a significant number of components that must be properly manufactured to provide smooth and consistent load transfer. This increases the overall cost of the assembly.

A need, therefore, exists for an improved CVT system that is less costly to manufacture, easier to maintain, and provides increased and efficient engine braking.

### SUMMARY OF THE INVENTION

A driven clutch for a continuously variable transmission is disclosed. The driven clutch includes an output shaft adapted to mate with a driven device, the output shaft having a shaft wall with at least one helix slot formed in the wall. The helix slot has at least one cam surface formed on it which defines an acceleration ramp and a deceleration ramp. The acceleration and deceleration ramps are circumferentially spaced apart from one another on the output shaft with the spacing of the ramps not being constant.

A first sheave is disposed about a portion of the output shaft, the first sheave being substantially axially restricted on the output shaft. The first sheave has a belt-engaging surface.

A second sheave is disposed about a portion of the output shaft and mounted so as to be axially and rotationally movable relative to the output shaft. The second sheave has a belt-engaging sin-face which faces the belt-engaging surface of the first sheave. The belt-engaging surfaces define a groove for receiving a belt from a drive clutch.

At least one cam follower is mounted to or engaged with the second sheave with a portion of the follower positioned within the helix slot so as to engage with the at least one cam surface during operation of the clutch. The contact between the cam follower and the cam surface permitting torque transmission between the second sheave and the output shaft. The driven clutch also includes a means for biasing the second sheave toward the first sheave, such as a spring.

In one embodiment, the cam follower includes a roller portion and a base portion, with the base portion mounted to the second sheave and the roller portion protruding radially inwardly to engage with the slot. Preferably there are three cam followers, and three slots formed in the output shaft, with a roller portion on each cam follower positioned within a respective slot.

In one embodiment, the helix slot is formed in the shaft at a location radially inward from the second sheave. In another embodiment, the acceleration ramp has a slope that is substantially linear over its entire length, and the deceleration ramp has a slope with a portion that is substantially linear and a portion that is curved such that the spacing between the acceleration and deceleration ramps in a slot varies from one end of the ramps to the other.

The first sheave is preferably mounted so as to be substantially rotatable relative to the output shaft, and the driven clutch includes an interlocking mechanism mounted so as to cause the first and second sheave to rotate in combination and which permits the second sheave to slide axially on the output shaft relative to the first sheave. In one configuration, the interlocking mechanism includes axial tracks formed on either the first or second sheave, and track sliders or rollers formed on the other of the first or second sheave. Each track slider or roller engages a track so as to permit relative axial movement of the first and second sheaves while rotatably coupling the first and second sheaves to one another.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings,

FIG. 1 is a schematic representation of a continuously variable transmission system including a driven clutch according to an embodiment of the present invention

FIG. 2 an isometric view of driven clutch for a continuously variable transmission system according to the present invention.

FIG. 3 is a cross-sectional view of the driven clutch of FIG. 2 taken along lines 3-3 in FIG. 2.

FIG. 4 is a side view of an output shaft in the clutch of FIG. 2.

FIG. 5 is a flat pattern enlargement illustrating one embodiment of the cam surface slots formed in the output shaft for the driven clutch according to FIG. 2.

FIG. 6 is a flat pattern enlargement of a prior art cam surface slot.

FIG. 7 is an exploded perspective view of a second embodiment of a driven clutch according to the present invention.

FIG. 8 is a cross-sectional view of the driven clutch of FIG. 7.

### DETAILED DESCRIPTION OF THE INVENTION

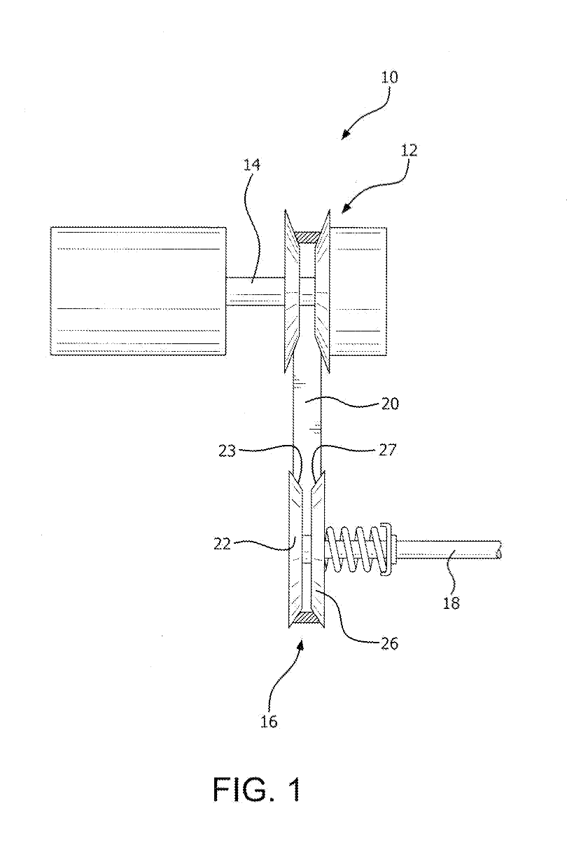

Referring to the drawings, wherein like reference numerals illustrate corresponding or similar elements throughout the several views, FIG. 1 depicts one embodiment of a continuously variable transmission (CVT) system 10 employing an improved driven clutch according to the present invention. While the details of the invention are described with reference to this particular type of CVT, it will be understood that variations in the structure and components of the basic CVT system may be made while still employing the substance of the invention.

The preferred system shown in the drawings includes a split sheave primary drive clutch 12 mounted to a rotatable input shaft 14 (which typically is connected directly to the vehicle's engine or engine output shaft.) A split sheave secondary driven clutch 16 is mounted to a rotatable driven shaft 18 (which, as described above, is typically connected to additional drive train components and ultimately to the drive axle and wheels of the vehicle.) An endless, preferably generally V-shaped flexible drive belt 20 is disposed around the two clutches. The CVT system in FIG. 1 is shown in its idle position. That is, the drive belt 20 is positioned near the periphery of the driven clutch 12 and near the center of the drive clutch 16.

The drive clutch 12 in the illustrated embodiment is preferably a conventional split sheave primary drive clutch and, thus, the details are not shown in the figures. The drive clutch 12 includes a laterally stationary sheave having an inner belt-engaging surface, a laterally movable sheave having a complementary inner belt-engaging, surface, and a coil spring for normally biasing the movable sheave away from the stationary sheave. The belt-engaging surfaces of the sheaves are tapered so that together they form generally the shape of a V with the angle of the V generally matching the V-shaped angle of the drive belt 20. Any conventional drive clutch with an engine braking, system feature can be used with the present invention.

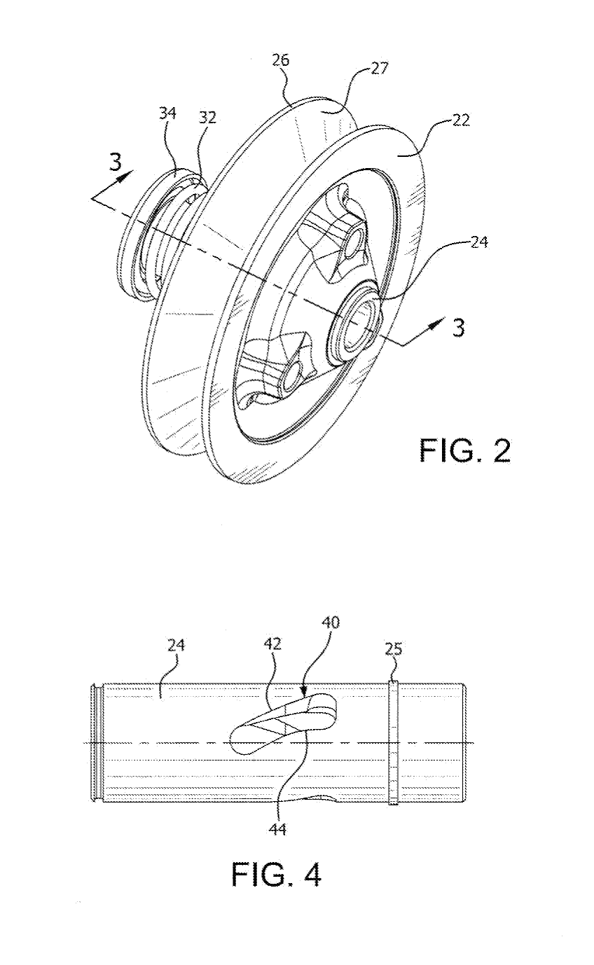

FIGS. 2-4 illustrate details of the construction of one embodiment of the improved driven clutch 16 of the present invention. The driven clutch 16 includes a laterally (axially) stationary first sheave 22 having an inner belt-engaging surface 23. The stationary sheave 22 includes an opening that is disposed about an end of an output shall 24. The stationary sheave 22 is mounted so as to be rotatable in combination with the output shaft 24. Preferably the stationary sheave 22 engages splines on an end of the shaft 24. An end cap or locking ring, can be used to prevent the stationary sheave 22 from sliding off the end of the shaft 24. A flange or raised surface 25 on the output shaft prevents the stationary sheave from moving laterally along the shaft.

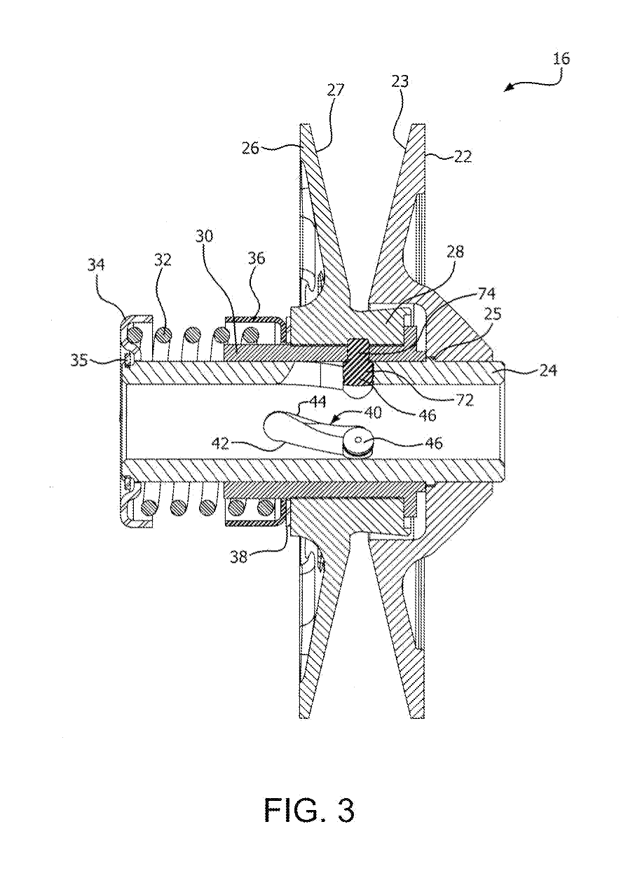

A laterally (axially) movable second sheave 26 is also carried on and disposed about the output shaft 24. The movable sheave 26 has an inner belt-engaging surface 27 that, together with the belt-engaging surface 23 of the stationary sheave 22, preferably defines a generally V-shaped groove in which the drive belt 20 is located. The movable sheave 26 is preferably disposed on the output shaft 24 such that it is capable of rotating with respect to the output shaft 24. The movable sheave 26 is also capable of translating axially (laterally) along the output shaft 24. More particularly, the movable sheave 26 has a mounting flange 28 that includes a preferably cylindrical portion which is disposed about a portion of the output shaft 24. The movable sheave may include a stub shaft 30 located between the mounting flange 28 and the output shaft 24 as shown in FIG. 3. In this embodiment, the movable sheave 26 is fixedly mounted to the stub shaft 30, such as with splines. The stub shaft 30, in turn, is slidable on the output shaft 24 so as to permit relative axial and rotational movement between the movable sheave 26 and the output shaft 24. Of course, it should be readily understood that the stub shaft 30 may be formed integrally with the movable sheave 26 or could be eliminated with the moveable sheave slidable and rotatably mounted directly on the output shaft 24.

A spring 32, preferably a compression or coil spring, is disposed between the movable sheave 26 and a retainer cap 34 that is mounted to a portion of the output shaft 24, preferably the end, such as with a locking clip 35. The clip 35 prevents the retainer cap 34 from sliding axially off of the shaft 24. The spring 32 engages a surface of the movable sheave 26 or, more preferably, engages a retainer cup 36 rotatably disposed about the stub shaft 30 and axially and rotatably movable relative to the shaft 24. A bushing, thrust washer, or other tow friction component 38 may be located between an outer surface of the movable sheave 26 and an outer surface of the retainer cup 36 so as to permit the movable sheave 26 to rotate relative to the retainer cup 36. The spring 32 urges or biases the movable sheave 26 toward the stationary sheave 22. Other types of mechanisms can be used to provide the necessary biasing and would be readily understood by those skilled in the art. The spring force or rate of the spring 32 is selected based on the anticipated loads acting on the driven clutch 16 and the type of drive clutch 12 used in the CVT.

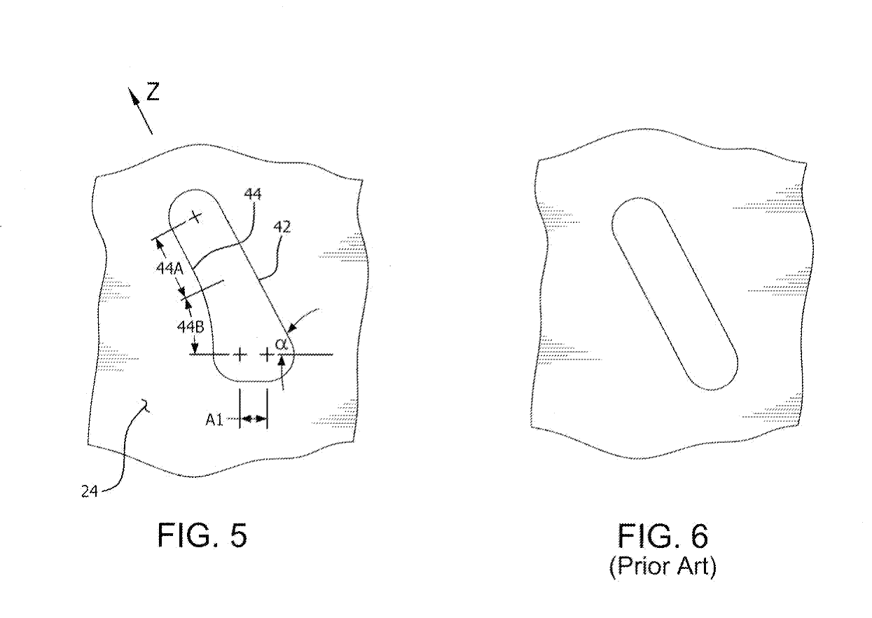

The output shaft 24 also includes at least one, and more preferably three circumferentially spaced apart helix slots 40 formed in the wall of the shaft. The shape of the helix slot 40 is designed so as to convey or transmit torque from the sheaves to the output shaft 24, while permitting relative rotational movement of the sheaves 22, 26 with respect to the output shaft 24 and axial movement of the movable sheave 26 relative to the output shaft 24. In order to permit the relative movement, the slot extends axially along and circumferentially about the output shaft 24, as shown in FIGS. 3 and 4. Specifically, each helix slot 40 includes an acceleration ramp or surface 42 that, in one embodiment, in a flat pattern layout preferably forms a linear slope as shown in FIG. 5. The angle of slope a of the acceleration ramp 42 relative to a plane extending along the axis of the output shaft 24 is determined by the desired performance characteristics of the clutch. The ramp 42 may alternately be a curved surface or compound surface.

Similarly, each slot 40 includes a spaced apart deceleration ramp or surface 44. The deceleration ramp 44 includes an upper portion 44A and a lower portion 44B. The upper portion 44A of the deceleration ramp preferably has a slope or shape that is substantially the same as the acceleration ramp 42 (i.e., a substantially similar curve, slope or surface). Thus, the spacing of the upper portion 44A of the deceleration ramp from the acceleration ramp 42 would be substantially constant. The lower portion 44B of the deceleration ramp includes a surface that extends further away from the acceleration ramp so as to form a larger spacing at the end of the deceleration ramp than at the beginning. This contrasts with the slots in the prior art, which is depicted in FIG. 6, that has a constant spacing along the entire length of the slot between the acceleration and deceleration ramps. In the illustrated embodiment of the present invention, the widest spacing A1 of the deceleration ramp 44B from the acceleration ramp 42 is at the lower end in FIG. 5 and is preferably approximately 0.200 inches greater than the spacing between the upper portion 44A of the deceleration ramp and the acceleration ramp 42. Also as shown in the illustrated embodiment, the lower portion 44B of the deceleration ramp forms almost a ninety degree angle with the axis of the shaft 24, however various other angles are possible.

The location where the deceleration ramp transitions away from being substantially the same shape as the acceleration ramp 42 determines the point where the engine braking comes into play. The longer the extent of the upper portion 44A, the greater the time before the engine braking commences. The shorter the extent of the upper portion 44A, the more immediate that engine braking kicks in. Thus, at high speed the system provides more coasting before engine braking kicks in. Also, the profile of lower portion 44B determines the spacing A1 and how aggressive the engine braking will be. For example, the steeper the angle or change of the lower portion 44B from the angle of the upper portion 44A, the more aggressive the engine braking. The smaller the angular difference the less aggressive the engine braking is. The profile of the lower portion can be varied, including angles, straight portions, curves, etc. depending on the engine braking effect desired. While the slots 40 are shown going completely through the cylindrical wall of the output shaft 24, it is also contemplated that they can be grooves cut into the surface of the shaft 24. In the illustrated embodiment, the helix slots 40 are formed through the wall on a portion of the output shaft 24 such that they are generally close to and preferably located axially and radially within the movable sheave 26 so as to provide a compact design.

The movable sheave 26 carries a set of cam followers 46. The cam followers can be any suitable type of follower used in CVT clutches, such as buttons or low friction rollers. The cam followers 46 are secured to the movable sheave 26 or, as shown in the illustrated embodiment, in the stub shaft 30. The cam followers 46 are positioned so as to engage or contact the ramps 42, 44 of the helix 40 at times during operation of the clutch. In one embodiment illustrated in FIG. 4, the cam followers 46 include a roller 72 rotatably mounted to a base portion 74 that is secured to the movable sheave 26 or if there is a stub shaft 30 as shown in FIG. 3, to the stub shaft) preferably with a clip or other attachment mechanism. This mourning arrangement permits the roller 72 to roll with respect to the base portion 74 and, thus, the movable sheave 26. It is also contemplated that the roller 72 and base portion 74 may be integral and mounted so that the roller can rotate in place.

As discussed above, the cam followers 46 contact the ramps 42, 44 during operation. More specifically, the ramps 42, 44 and spring 32 operate to urge the cam followers 46 and, therefore, the movable sheave 26 toward the stationary sheave 22 in response to torque applied by the belt to the movable sheave 26. That is, as the belt is driven by the drive clutch 12 (normal drive mode), the belt rotates the sheaves 22, 26 of the driven clutch 16. As discussed above, the movable sheave 22 is not rotationally secured to the output shaft 24. Hence, it will rotate with respect to the output shaft 24 and the helix 40 until the roller portion 72 of each cam follower 46 contacts with an associated acceleration ramp 42 on the helix 40. The axial displacement of the movable sheave is, at that point, counteracted by the acceleration ramp 42 and compression spring 44, which resist the opening of the movable sheave 26 (i,e., urge the movable sheave 26 toward the stationary sheave 22). Thus, as torque is applied to the movable sheave 26 by the belt, the sheaves continue to pinch the belt, assuring good frictional contact between the belt and the sheaves.

When power is removed or the vehicle begins to decelerate, the torque that is applied to the sheaves 22, 26 is briefly relieved or reduced. The momentary reduction in loading permits the output shaft 24 to rotate with respect to the movable sheave 26. Thus, the helix 40 moves with the shaft relative to the cam followers 46 causing them to move from the acceleration ramps 42 to the deceleration ramps 44. At this point, the shaft 24 is again engaged to the movable sheave 22, and the spring 32 and the deceleration ramp 44 bias the movable sheave 26 toward the stationary sheave 22, enabling, the clutch to transmit torque through the sheaves back to the engine. The engine compression then operates to produce braking/slowing of the vehicle.

Should the vehicle begin rolling forward with the CVT in its idle position (i.e., the throttle is not activated), the driven clutch allows the CVT to backdrive the engine, thereby providing engine braking. The backdriving, occurs as follows. Assume that, as is illustrated in FIGS. 2 and 3 which depict the driven CVT clutch 16 in the idle position, the output shaft rotates in the counterclockwise direction during normal operation when the engine drives the drive shaft 24. When in idle, the forward rolling motion of the vehicle causes the wheels, axles, and associated drive train components to backdrive the CVT output shaft 24 in the counterclockwise direction. The helix 40 will, thus, rotate counterclockwise with the output shaft 24 until the deceleration ramps 44 contact the earn followers 46 carried by the movable sheave 26. No movement of the sheaves 22, 26 or the drive belt 20 occurs until the helix 40 contacts the cam followers 46. At that point, the deceleration ramps 44 and spring 32 resist the opening of the clutch (movable sheave movable sheave 26 moving away from the stationary sheave 22).

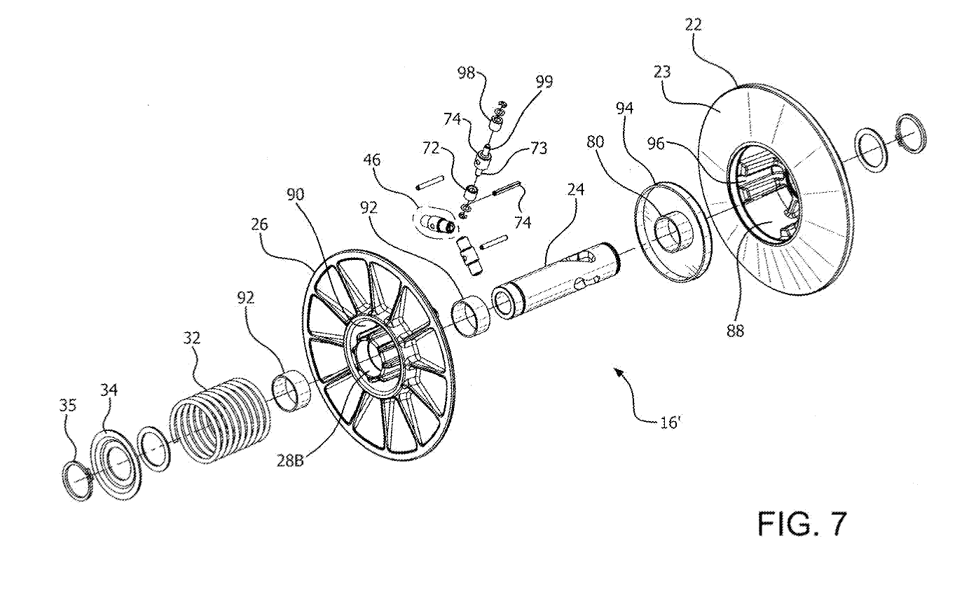

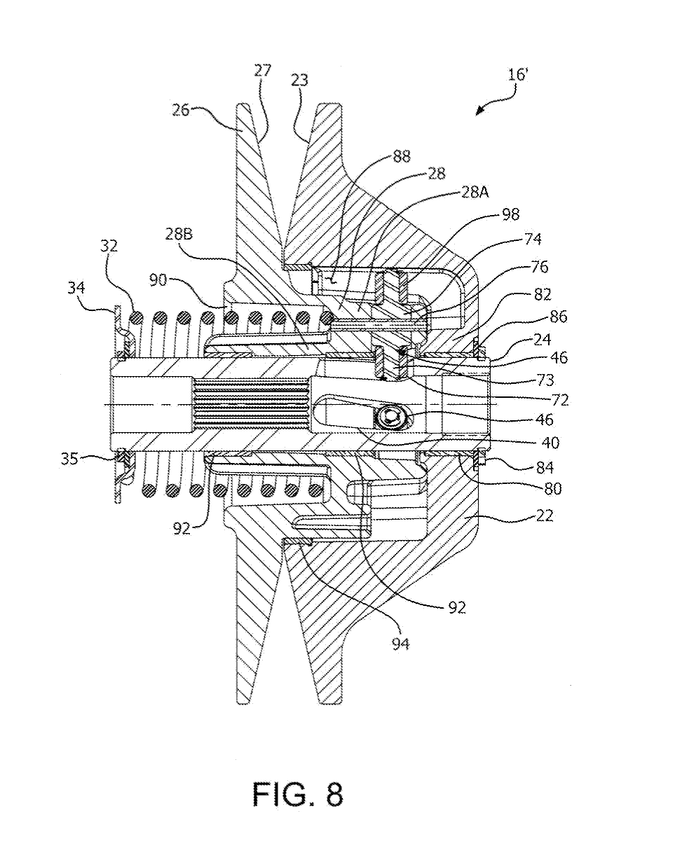

As the movable sheave 26 rotates and is urged toward the stationary sheave 22, the belt 20 is forced into the stationary sheave 22. In the embodiment shown in FIG. 3, since the stationary sheave 22 is fixedly attached to the shaft 22, the result can produce some frictional scrubbing of the belt on the belt engaging surface 23. As will be discussed below, an alternate embodiment is presented in FIGS. 7 and 8 which reduces or eliminates the belt scrub.

The radially outward movement of the belt 20 on the driven clutch 16 produces a tightening (radially inward transition) of the belt 20 on the drive clutch 12. The rotation of the driven clutch 16 is, thus, imparted to the belt and to the drive clutch 12 on the input shaft 14. If the speed of rotation of the drive clutch 12 caused by the drivetrain backdriving the CVT exceeds the speed of rotation of the input shaft 14 caused by the engine, the drive clutch 12 will lock onto the shaft 14, causing the shaft 14 and engine to rotate faster than they otherwise would. The compression of the engine cylinders (and other frictional forces in the engine) will act against this increased speed of rotation and, as a result, slow the rotation of the entire drive train (including the CVT) of the vehicle, hence providing engine braking.

An alternate embodiment of the invention is shown in FIGS. 7 and 8, which is designed to reduce or eliminate belt scrubbing that may occur in the previous embodiment. As with the prior embodiment, the driven clutch 16 includes a stationary or first sheave 22, with a belt engaging surface 23 on one face of the sheave, and a moveable or second sheave 26, with a belt engaging surface 27 on the face which faces the belt engaging surface 23 of the first sheave 22. A key difference in this embodiment is that both the first and second sheaves are disposed and rotatable about the shaft 24. Specifically, a bushing or low friction sleeve 80 is located between a radially inner surface 82 of the first sheave 22 and a surface on the shaft 24. The bushing permits the first sheave to rotate freely about the shaft 24 (although as will be discussed below, the rotational and axial movement of the first sheave is constrained by the second sheave and the shaft.) A locking ring 84 snaps into a notch on the shaft 24, thus prohibiting the first sheave 22 from sliding off the end of the shaft 24. A washer 86 may be incorporated between a face on the first sheave 22 and the locking ring 84.

The second or movable sheave 26 includes a mounting flange 28 with a roller mounting portion 28A and a shaft mounting portion 28B. The roller mounting portion 28A extends axially away from the belt contacting surface 27 on the second sheave 26 and is adapted to be positioned within an interior cavity 88 formed within the first sheave 22. The shaft mounting portion 28B is disposed over a portion of the shaft 24. Preferably the shaft mounting portion 28B extends in the opposite direction from the roller mounting portion 28A and is located within a cavity 90 within the second sheave 26. In one embodiment, there is at least one and more preferably multiple bearings 92 located between a radially inner surface of the shaft mounting portion 28B and the outer surface of the shaft 24 so as to provide a low friction interface designed to permit the second sheave 26 to rotate relative to the shaft 24.

Due to the compact arrangement in this embodiment, it may be preferable to support the first sheave 22 with the second sheave 26. More specifically a surface on the first sheave 22 inside the cavity 88 preferably rests on a portion of the mounting flange 28. A bushing 94 may be located between the surfaces so as to facilitate relative movement between the two sheaves.

As with the first embodiment, this embodiment of the driven clutch includes a spring 32 that is positioned between a rear surface of the second sheave, opposite from the belt engaging surface 27, and a retainer cap 34. The retainer cap 34 is held axially onto the shaft by a locking clip 35. One end of the coil spring contacts an inner facing surface of the retainer cap 34 and the other end of the coil spring 32 contacts the second sheave 26, preferably within the cavity 90.

As with the prior embodiment, the shaft 24 includes one or more slots 40 termed in the shaft between its ends. The slots 40 are similar to the slots described above and, therefore, no further discussion is necessary. Cam followers 46 are mounted to the roller mounting portion 28A. More particularly, each cam follower 46 includes a base portion 74 preferably fixedly mounted to the roller mounting portion 28A, such as with a pin 76 although other mounting mechanisms can be used. A roller 72 is rotatably mounted to a base shaft 73 of the base portion 74 such that the roller 72 can rotate about the base shaft.

In order to eliminate scrubbing between the belt and the first sheave 22, a slidable connection is incorporated between the first sheave 22 and the second sheave 26. More specifically, the first sheave 22 includes one or more axial tracks 96 formed on the radially outer surfaces of the cavity 88. The tracks 96 extend along a portion of the axial length of the cavity 88. Rollers or slides 98 are mounted to the second sheave 26, preferably on the roller mounting portion 28A, and engage with the tracks 96 so as to rotatably interlock the first and second sheaves causing the sheaves to rotate together. The axial tracks allow the sheaves to move axially toward and away from one another (or at least allows the second sheave to move axially relative to the firs sheave. It is also contemplated that the interlocking arrangement can be reversed with the tracks on the second sheave and the sliders or rollers on the first sheave.

In the illustrated embodiment, the rollers 98 are preferable mounted to the base portion 74. For example, as shown in FIGS. 7 and 8, the rollers 98 are preferably rotatably mounted on a roller shaft. 99 that extends radially outward from the base portion 74. Other mounting arrangements can be used and would be evident to a person skilled in the art in light of the above discussion.

The operation of this embodiment of the driven clutch 16′ is similar to the prior embodiment. However, since the first sheave 22 is not directly connected to the output shaft 24, the first sheave 22 rotates in combination with the second sheave 26. Since the second sheave 26 is connected to the shaft 24 through the slots 46 and the rollers 72, the second sheave 26 and the first sheave 22 rotate in combination with the output shaft 24. As a result, the rotation of the sheaves 22, 26 drives the belt with limited frictional resistance. The rotation of the first sheave 22 prevents the belt from scrubbing., thus allowing torque to transmit through the driven clutch 16.

During operation, if the operator is driving the vehicle at an intermediate or high speed and then lets off on the throttle, e.g., brings the throttle to idle, the rotation of the engine (and the CVT components) would ordinarily drop more quickly than the speed of the vehicle the vehicle's wheels). The vehicle's wheels and associated drivetrain, thus, begin to backdrive, the output shaft 24 of the CVT. Normally the torque applied by the drive clutch 12 and belt to the torque-sensitive driven clutch 16 drops with the decrease in engine speed. This produces a decrease in the pinching force on the belt which causes a conventional CVT to lose its balance of forces and making it unable to backdrive the engine.

The driven clutch 16 according to the present invention, however, permits the sheaves to adjust for the change in torque. More particularly, the reduction in the commanded acceleration and associated decrease in the pinching force reduces the frictional connection between the first sheave 22 and the output shaft 24 caused by the pinching. As a consequence, the first sheave 22 is momentarily frictionally unlocked from the output shaft 24, thereby permitting the first sheave 22 and second sheave 26 to rotate together with the belt (with no scrubbing against the side drive surfaces of the belt) relative to the output shaft 22 and the helix 40, until the cam followers 46 carried by the second sheave 26 encounter the deceleration ramps 44 of the helix 40. At that point the helix's deceleration ramps 44 (being driven by the vehicle wheels and drivetrain) and the compression spring urge the cam followers 46 and the second sheave 26 toward the first sheave 22 again locking the first sheave 22 to the output shaft 24. Torque is then transmitted from the output shaft 24, through the helix 40/second sheave 26 and into the belt 20. The belt then transmits the backdriving of the vehicle drive train through the drive clutch 12 to the engine, resulting in engine braking to the vehicle.

The improved CVT driven clutch described above provides a unique system for efficiently transmitting torque, both during normal operation and during engine braking. The new clutch arrangement described above is also more economical than conventional clutches.

The present invention may be embodied in other specific forms without departing from the spirit or essential attributes thereof and, accordingly, reference should be made to the appended claims, rather than to the foregoing specification, as indicating the scope of the invention.

What is claimed is:

1. A driven clutch for a continuously variable transmission comprising:
an output shaft adapted to mate with a driven device the output shaft having a shaft wall with at least one helix slot formed in the wall, the helix slot having at least one cam surface formed thereon which defines an acceleration ramp and a deceleration ramp, the acceleration and deceleration ramps being circumferentially spaced apart from one another on the output shaft, the spacing of the ramps not being constant;
a first sheave disposed about a portion of the output shaft, the first sheave being substantially axially restricted on the output shaft, the first sheave having a belt-engaging surface;
a second sheave disposed about a portion of the output shaft and mounted so as to be axially and rotationally movable relative to the output shaft, the second sheave having a belt-engaging surface which faces the belt-engaging surface of the first sheave, the belt-engaging surfaces defining a groove for receiving a belt from a drive clutch;
at least one cam follower mounted to or engaged with the second sheave, and wherein a portion of the follower is positioned within the helix slot so as to engage, with the at least one cam surface during operation of the clutch, the contact between the cam follower and the cam surface permitting torque transmission between the second sheave and the output shaft; and
means for biasing the second sheave toward the first sheave.

2. A driven clutch according to claim 1 wherein the cam follower includes a roller portion and a base, portion, the base portion mounted to the second sheave and the roller portion positioned within the slot, and wherein the roller portion protrudes radially inwardly to engage with the slot.

3. A driven clutch according to claim 2 wherein there are three cam followers, and three slots formed in the output shaft, and wherein a roller portion on each cam follower is positioned within a respective slot.

4. A driven clutch according to claim 3 wherein the helix slots are formed in the shaft at a location radially inward from the second sheave.

5. A driven clutch according to claim 3 wherein the means for biasing includes a compression spring.

6. A driven clutch according to claim 1 wherein the driven clutch is part of continuously variable transmission, the transmission comprising a drive clutch mounted to an input shaft engaged with an engine, and a belt disposed about the drive clutch and between the belt engaging surfaces of the driven clutch.

7. A driven clutch according to claim 1 wherein there are three cam followers, and three slots formed in the output shaft, each slot including a respective acceleration and deceleration ramp, the slots being formed in the shaft at a location radially inward from the second sheave, and wherein each cam follower includes a portion that is within a respective slot and positioned so as to engage with the acceleration and deceleration ramps in that slot during operation of the driven clutch.

8. A driven clutch according to claim 1 wherein the acceleration ramp has a slope that is substantially linear over its entire length, and wherein the deceleration ramp has a slope with a portion that is substantially linear and a portion that is curved such that the spacing between the acceleration and deceleration ramps in a slot varies from one end of the ramps to the other.

9. A driven clutch according to claim I wherein the first sheave is mounted so as to be substantially rotatable relative to the output shaft, the driven clutch includes an interlocking mechanism mounted so as to cause the first and second sheave to rotate in combination and which permits the second sheave to slide axially on the output shaft relative to the first sheave.

10. A driven clutch according to claim 9 wherein the interlocking mechanism includes axial tracks formed on either the first or second sheave, and track sliders or rollers formed on the other of the first or second sheave, each track slider or roller engaging as track so as to permit relative axial movement of the first and second sheaves while rotatably coupling the first and second sheaves to one another.

11. A driven clutch according to claim 10 wherein there are multiple cam followers and multiple slots, each cam follower including a roller portion and a base portion, the base portion mounted to the second sheave and the roller portion positioned within the slot, the roller portion protrudes radially inwardly to engage with the slot, and wherein the each track slider or roller is mounted to the base portion of one of the cam followers and located radially outwardly from the location of the roller portion.

12. A continuously variable transmission system comprising:
an input shaft adapted to engage an engine;
a drive clutch engaged with the input shaft and having belt engaging surfaces;
a driven clutch including:
an output shaft adapted to mate with a driven device, the output shaft having a shaft wall with at least one helix slot formed through the wall, the helix slot having at least one cam surface formed thereon which includes an acceleration ramp and a deceleration ramp, the acceleration and deceleration ramps being circumferentially spaced apart from one another on the output shaft, the spacing of the ramps not being constant;
a first sheave disposed about a portion of the output shaft, the first sheave being substantially axially restrained and having a belt-engaging surface;
a second sheave disposed about a portion of the output shaft and mounted so as to be axially and rotationally movable relative to the output shaft, the second sheave having a belt-engaging surface which faces the belt-engaging surface of the first sheave, the belt-engaging surfaces defining a groove for receiving a belt from a drive clutch;
at least one cam follower mounted to or engaged with the second sheave with a portion of the follower positioned within the helix slot so as to engage with the at least one cam surface during operation of the clutch, the contact between the cam follower and the cam surface permitting torque transmission between the second sheave and the output shaft; and
means for biasing the second sheave toward the first sheave: and
an endless flexible drive belt disposed about the drive and driven clutches and engaged with the belt engaging surfaces, the belt providing torque transmission between the drive and driven clutches.

13. The transmission system of claim 12 wherein the acceleration ramp has a slope that is substantially linear over its entire length, and wherein the deceleration ramp has a slope with a portion that is substantially linear and a portion that is curved such that the spacing between the acceleration and deceleration ramps in a slot varies from, one end of the ramps to the other.

14. The transmission system of claim 12 wherein the cam follower includes a roller portion and a base portion, the base portion mounted to the second sheave and the roller portion positioned within the slot.

15. The transmission system of claim 12 wherein there are three cam followers, and wherein the at least one helix slot is three slots formed in and circumferentially spaced about the wall, each slot including a respective acceleration and deceleration ramp, wherein each cam follower includes a portion that is within a respective slot and positioned so as to engage with the acceleration and deceleration ramps in that slot during operation of the driven clutch, and wherein the deceleration ramp has a slope with a portion that is substantially linear and a portion that is curved such that the spacing between the acceleration and deceleration ramps in a slot varies from one end of the ramps to the other.

16. The transmission system of claim 15 wherein the slot is formed in the shaft member at a location radially inward from the second sheave.

17. The transmission system of claim 13 wherein the means for biasing includes a compression spring.

18. The transmission system of claim 12 wherein the first sheave is mounted so as to be substantially rotatable relative to the output shaft, the driven clutch includes an interlocking mechanism mounted so as to cause the first and second sheave to rotate in combination and which permits the second sheave to slide axially on the output shaft relative to the first sheave.

19. The transmission system of claim 18 wherein the interlocking mechanism includes axial tracks formed on either the first or second sheave, and track sliders or rollers formed on the other of the first or second sheave, each track slider or roller engaging a track so as to permit relative axial movement of the first and second sheaves while rotatably coupling the first and second sheaves to one another.

20. The transmission system of claim 19 wherein there are multiple cam followers and multiple slots, each cam follower including a roller portion and a base portion, the base portion mounted to the second sheave and the roller portion positioned within the slot, the roller portion protrudes radially inwardly to engage with the slot, and wherein the each track slider or roller is mounted to the base portion of one of the cam followers and located radially outwardly from the location of the roller portion.

21. A torque-sensing driven clutch, comprising:
a shaft member adapted to mate with a driven device and including a cylindrical wall, a torque-transmitting slot formed in the cylindrical wall, the slot including an acceleration ramp surface and a deceleration ramp surface, the acceleration and deceleration ramp surfaces being circumferentially spaced apart from one another, the spacing of the ramps not being constant;
a first sheave operatively connected to the cylindrical shaft member, the first sheave being substantially restrained from longitudinal movement on the shaft member;
a second sheave longitudinally moveable and rotatable on the shaft member;
a first connector mounted to the second sheave with a portion positioned within the slot in the shaft member and adapted to engage with the acceleration and deceleration ramp surfaces during operation so as to connect the second sheave and the output shaft for rotating the second sheave and for moving the second sheave longitudinally on the shaft member; and
a spring positioned between a portion of the second sheave and an end of the shaft member for biasing the second sheave toward the first sheave.

22. The driven clutch of claim 21 wherein the first sheave is mounted so as to be substantially rotatable relative to the output shaft, the driven clutch including an interlocking mechanism mounted so as to cause the first and second sheave to rotate in combination and which permits the second sheave to slide axially on the output shaft relative to the first sheave.

23. The driven clutch of claim 22 wherein the interlocking mechanism includes axial tracks formed on either the first or second sheave, and track sliders or rollers formed on the other of the first or second sheave, each track slider or roller engaging a track so as to permit relative axial movement of the first and second sheaves while rotatably coupling the first and second sheaves to one another.

24. The driven clutch of claim 23 wherein there are multiple cam followers and multiple slots, each cam follower including a roller portion and a base portion, the base portion mounted to the second sheave and the roller portion positioned within the slot, the roller portion protrudes radially inwardly to engage with the slot, and wherein the each track slider or roller is mounted to the base portion of one of the cam followers and located radially outwardly from the location of the roller portion.
